(19) United States
(12) Patent Application Publication
(10) Pub. No.: US 2022/0041165 A1
(43) Pub. Date: Feb. 10, 2022

(54) INFORMATION PROCESSING DEVICE, INFORMATION PROCESSING METHOD, COMPUTER PROGRAM PRODUCT, INFORMATION PROCESSING SYSTEM, AND VEHICLE CONTROL SYSTEM

(71) Applicant: KABUSHIKI KAISHA TOSHIBA, Tokyo (JP)

(72) Inventors: Rie KATSUKI, Kawasaki (JP); Toshimitsu KANEKO, Kawasaki (JP); Masahiro SEKINE, Fuchu (JP)

(73) Assignee: KABUSHIKI KAISHA TOSHIBA, Tokyo (JP)

(21) Appl. No.: 17/182,295

(22) Filed: Feb. 23, 2021

(30) Foreign Application Priority Data
Aug. 7, 2020 (JP) 2020-134810

(51) Int. Cl. B60W 30/18; G05D 1/02; B60W 30/095; B60W 30/09

(52) U.S. Cl. CPC B60W 30/18163; G05D 1/0221; G05D 1/0223; G05D 1/0289; B60W 2554/803; B60W 30/09; G05D 2201/0213; B60W 2554/4045; B60W 30/0956

(57) ABSTRACT

An information processing device according to an embodiment includes one or more hardware processors. The processors generate a plurality of nodes at positions corresponding to an operation indicated by an avoidance pattern to avoid a first object on a first trajectory based on one or more avoidance patterns indicating one or more operations of a mobile object for avoiding an object. The processors search for a trajectory candidate whose moving cost is smaller than that of another trajectory candidate among a plurality of trajectory candidates connecting a plurality of nodes for each avoidance pattern. The processors select a trajectory candidate whose moving cost is smaller than that of another trajectory candidate from among one or more trajectory candidates searched for each avoidance pattern.

### CROSS-REFERENCE TO RELATED APPLICATIONS

This application is based upon and claims the benefit of priority from Japanese Patent Application No. 2020-134810, filed on Aug. 7, 2020; the entire contents of which are incorporated herein by reference.

### FIELD

An embodiment described herein relates generally to an information processing device, an information processing method, a computer program product, an information processing system, and a vehicle control system.

### BACKGROUND

Automatic driving technology for automatically steering automobiles has drawn attention. For example, a technology for generating a trajectory to avoid a collision with an object such as an obstacle is disclosed. Further, there is disclosed a technology of arranging nodes in a drivable region and searching for a trajectory having a low drive cost among a plurality of trajectories that sequentially pass through a plurality of nodes from the current location to the destination. For example, in order to improve the obstacle avoidance performance, a technology has been proposed in which nodes are densely sampled around an obstacle existing in the drivable region.

However, in the conventional art, the nodes are uniformly and densely arranged around the obstacle. As such, there are cases where the time required to generate the trajectories increases.

### BRIEF DESCRIPTION OF THE DRAWINGS

FIG. 1 is a diagram illustrating an example of a mobile object;

FIG. 2 is a block diagram illustrating an example of a mobile object;

FIG. 3 is a schematic diagram illustrating an example of a reference trajectory;

FIG. 4 is a schematic diagram illustrating a search space;

FIG. 5A is an explanatory diagram of the search space;

FIG. 5B is an explanatory diagram of the search space;

FIG. 6A is a diagram illustrating an example of the operation constituting an avoidance pattern;

FIG. 6B is a diagram illustrating an example of the operation constituting an avoidance pattern;

FIG. 6C is a diagram illustrating an example of the operation constituting an avoidance pattern;

FIG. 6D is a diagram illustrating an example of the operation constituting an avoidance pattern;

FIG. 7 is a diagram illustrating an example of a method of generating a way point (WP) corresponding to a deviation start node;

FIG. 8 is a diagram illustrating an example of a method of generating a WP corresponding to a deviation end node;

FIG. 9 is a diagram illustrating an example of WPs arranged around a WP;

FIG. 10 is a diagram illustrating an example of a new reference trajectory;

FIG. 11 is a diagram illustrating an example of a method of generating a merging complete node;

FIG. 12 is a diagram illustrating an example of WPs arranged around a WP;

FIG. 13 is a conceptual diagram illustrating a recursive search for trajectory candidates;

FIG. 14 is a diagram illustrating an output example of an avoidance pattern;

FIG. 15 is a flowchart of trajectory generation processing;

FIG. 16 is a flowchart of trajectory generation processing for avoiding obstacles;

FIG. 17 is a flowchart of obstacle avoidance route search processing;

FIG. 18 is a block diagram of an information processing system of a variation example; and

FIG. 19 is a hardware configuration diagram of the device of the embodiment.

### DETAILED DESCRIPTION

An information processing device according to an embodiment includes one or more hardware processors. The processors generate a plurality of nodes at positions corresponding to an operation indicated by an avoidance pattern to avoid a first object on a first trajectory based on one or more avoidance patterns indicating one or more operations of a mobile object for avoiding an object. The processors search for a trajectory candidate whose moving cost is smaller than that of another trajectory candidate among a plurality of trajectory candidates connecting a plurality of nodes for each avoidance pattern. The processors select a trajectory candidate whose moving cost is smaller than that of another trajectory candidate from among one or more trajectory candidates searched for each avoidance pattern.

The information processing device, the information processing method, the computer program product, the information processing system, and the vehicle control system will be described in detail with reference to the accompanying drawings.

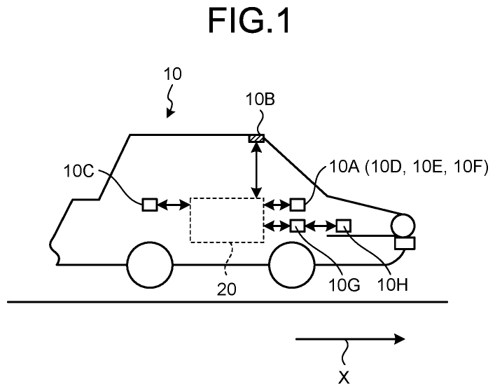

FIG. 1 is a diagram illustrating an example of a mobile object 10 of the present embodiment.

The mobile object 10 (an example of the vehicle control system) includes an information processing device 20, an output unit 10A, a sensor 10B, an input device 10C, a power control unit 10G (an example of a power control device), and a power unit 10H.

The information processing device 20 searches for trajectories of the mobile object 10 (details will be described later). The information processing device 20 is, for example, a dedicated or general-purpose computer. In the present embodiment, the case where the information processing device 20 is mounted on the mobile object 10 will be described as an example.

The mobile object 10 is a movable materiality. The mobile object 10 is, for example, a vehicle (motorcycle, four-wheeled vehicle, bicycle), a trolley, a robot, a ship, and a flying object (an airplane, an unmanned aerial vehicle (UAV), etc.). The mobile object 10 is, for example, a mobile object that drives through a driving operation by a person, and a mobile object that can automatically drive (autonomously drive) without a driving operation by a person. The mobile object capable of autonomous driving is, for example, an automatic driving vehicle. The case where the mobile object 10 of the present embodiment is a vehicle capable of autonomous driving will be described as an example.

Note that the information processing device 20 is not limited to the form of being mounted on the mobile object 10. The information processing device 20 may be mounted on a stationary object. The stationary object is an object that is not movable and is stationary with respect to the ground. The stationary object includes, for example, guardrails, poles, parked vehicles, and road signs. Further, the information processing device 20 may be mounted on a cloud server that executes processing on the cloud.

The output unit 10A outputs various information. In the present embodiment, the output unit 10A outputs output information.

The output unit 10A includes, for example, a communication function for transmitting the output information, a display function for displaying the output information, a sound output function for outputting a sound indicating the output information, and the like. For example, the output unit 10A includes a communication unit 10D, a display 10E, and a speaker 10F.

The communication unit 10D communicates with an external device. The communication unit 10D is a VICS (registered trademark) communication circuit, a dynamic map communication circuit, and the like. The communication unit 10D transmits the output information to the external device. Further, the communication unit 10D receives road information and the like from the external device. The road information is traffic lights, signs, surrounding buildings, road widths in each lane, lane centerlines, and the like. The road information may be stored in a storage unit 20B.

The display 10E displays the output information. The display 10E is, for example, a known liquid crystal display (LCD), a projection device, a light, or the like. The speaker 10F outputs a sound indicating the output information.

The sensor 10B is a sensor that acquires the driving environment of the mobile object 10. The driving environment is, for example, observation information of the mobile object 10 and peripheral information of the mobile object 10. The sensor 10B is, for example, an outer field sensor and an inner field sensor.

The inner field sensor is a sensor that observes the observation information of the mobile object 10. The observation information includes at least one of the acceleration of the mobile object 10, the speed of the mobile object 10, and the angular velocity of the mobile object 10.

The inner field sensor is, for example, an inertial measurement unit (IMU), an acceleration sensor, a speed sensor, and a rotary encoder. The IMU observes observation information including a triaxial acceleration and a triaxial angular velocity of the mobile object 10.

The outer field sensor observes the peripheral information of the mobile object 10. The outer field sensor may be mounted on the mobile object 10 or may be mounted on the outside of the mobile object 10 (for example, another mobile object and external device).

The peripheral information is information indicating the situation around the mobile object 10. The periphery of the mobile object 10 is a region within a predetermined range from the mobile object 10. This range is the observable range of the outer field sensor. It is sufficient if this range is set in advance.

The peripheral information is, for example, at least one of a captured image and distance information around the mobile object 10. Note that the peripheral information may include position information of the mobile object 10. The captured image is captured image data obtained by capturing (hereinafter, it may be simply referred to as the captured image). The distance information is information indicating the distance from the mobile object 10 to the object. The object is a part of the outside that can be observed by the outer field sensor. The position information may be a relative position or an absolute position.

The outer field sensor is, for example, a capture device that obtains a captured image by capturing, a distance sensor (millimeter wave radar, a laser sensor, a distance image sensor), and a position sensor (global navigation satellite system (GNSS), global positioning system (GPS), wireless communication device).

The captured image is digital image data in which a pixel value is specified for each pixel, a depth map in which the distance from the sensor 10B is specified for each pixel, and the like. The laser sensor is, for example, a two-dimensional laser imaging detection and ranging (LIDAR) sensor installed parallel to the horizontal plane, and a three-dimensional LIDAR sensor.

The input device 10C receives various instructions and information input from the user. The input device 10C is, for example, a pointing device such as a mouse and a trackball, or an input device such as a keyboard. Further, the input device 10C may be an input function in a touch panel provided integrally with the display 10E.

The power control unit 10G controls the power unit 10H. The power unit 10H is a driving device mounted on the mobile object 10. The power unit 10H is, for example, an engine, a motor, wheels, and the like.

The power unit 10H is driven by the control of the power control unit 10G. For example, the power control unit 10G determines the surrounding situation on the basis of the output information generated by the information processing device 20, the information obtained from the sensor 10B, and the like, and controls the accelerator amount, the brake amount, the steering angle, and the like. For example, the power control unit 10G controls the power unit 10H of the mobile object 10 so that the mobile object 10 moves according to a route generated by the information processing device 20.

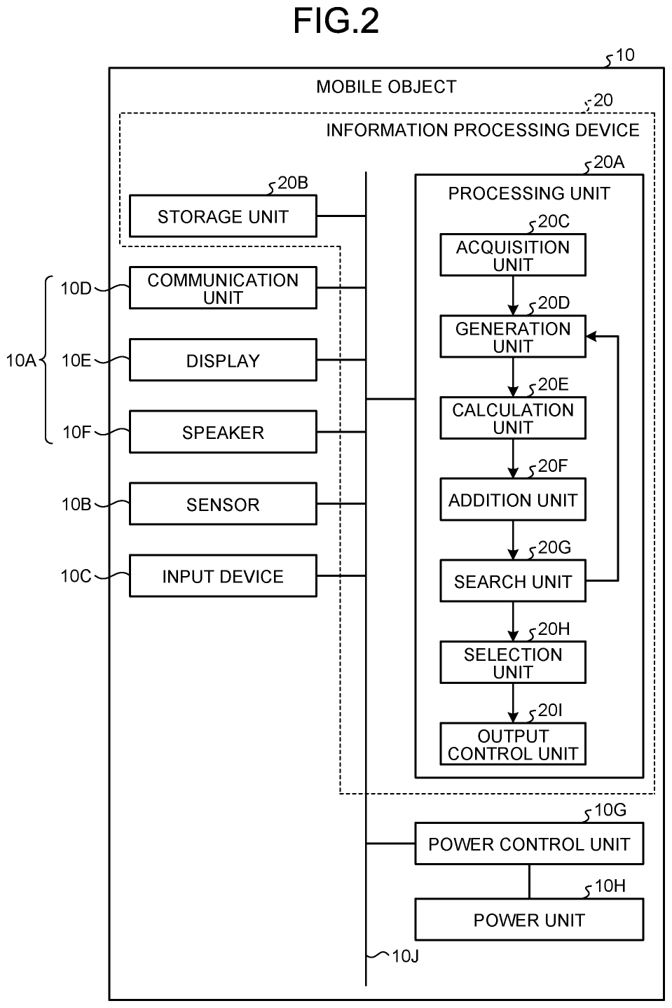

Next, the electrical configuration of the mobile object 10 will be described in detail. FIG. 2 is a block diagram illustrating an example of the configuration of the mobile object 10.

The mobile object 10 includes the information processing device 20, the output unit 10A, the sensor 10B, the input device 10C, the power control unit 10G, and the power unit 10H. As described above, the output unit 10A includes the communication unit 10D, the display 10E, and the speaker 10F.

The information processing device 20, the output unit 10A, the sensor 10B, the input device 10C, and the power control unit 10G are connected via a bus 10J. The power unit 10H is connected to the power control unit 10G.

The information processing device 20 includes the storage unit 20B and a processing unit 20A. That is, the output unit 10A, the sensor 10B, the input device 10C, the power control unit 10G, the processing unit 20A, and the storage unit 20B are connected to the processing unit 20A via the bus 10J.

Note that it is sufficient if at least one of the storage unit 20B, the output unit 10A (communication unit 10D, display 10E, speaker 10F), the sensor 10B, the input device 10C, and the power control unit 10G is connected to the processing unit 20A by wire or wirelessly. Further, at least one of the storage unit 20B, the output unit 10A (communication unit 10D, display 10E, speaker 10F), the sensor 10B, the input device 10C, and the power control unit 10G may be connected to the processing unit 20A via a network.

The storage unit 20B stores various data. The storage unit 20B is, for example, a semiconductor memory element such as a random access memory (RAM) and a flash memory, a hard disk, an optical disk, or the like. Note that the storage unit 20B may be provided outside the information processing device 20. Further, the storage unit 20B may be provided outside the mobile object 10. For example, the storage unit 20B may be arranged in a server device installed on the cloud.

Further, the storage unit 20B may be a storage medium. Specifically, the storage medium may be a medium in which a program and various information are downloaded via a local area network (LAN), the Internet, or the like and stored or temporarily stored. Further, the storage unit 20B may be composed of a plurality of storage media.

The processing unit 20A includes an acquisition unit 20C, a generation unit 20D, a calculation unit 20E, an addition unit 20F, a search unit 20G, a selection unit 20H, and an output control unit 20I.

Each processing function in the processing unit 20A is stored in the storage unit 20B in the form of a program that can be executed by a computer. The processing unit 20A is a processor that realizes a functional unit corresponding to each program by reading and executing a program from the storage unit 20B.

The processing unit 20A in the state where each program is read has each functional unit illustrated in the processing unit 20A of FIG. 2. In FIG. 2, description is given of the assumption that the acquisition unit 20C, the generation unit 20D, the calculation unit 20E, the addition unit 20F, the search unit 20G, the selection unit 20H, and the output control unit 20I are realized by a single processing unit 20A.

Note that the processing unit 20A may be configured by combining a plurality of independent processors for realizing each of the functions. In this case, each function is realized by each processor executing a program. Further, each processing function may be configured as a program, and one processing circuit may execute each program, or a specific function may be implemented in a dedicated independent program execution circuit.

Note that the term “processor” used in the present embodiment means, for example, a central processing unit (CPU), a graphical processing unit (GPU), an application specific integrated circuit (ASIC), or a circuit of a programmable logic device (for example, simple programmable logic device (SPLD), a complex programmable logic device (CPLD), and a field programmable gate array (FPGA)).

The processor realizes the function by reading and executing the program stored in the storage unit 20B. Note that, instead of storing the program in the storage unit 20B, the program may be directly configured to be incorporated in the circuit of the processor. In this case, the processor realizes the function by reading and executing the program incorporated in the circuit.

When the trajectory of the mobile object 10 collides with an object such as an obstacle, the processing unit 20A generates a trajectory that avoids the object. Colliding with the object means touching the object or driving on the object on the assumption that the mobile object 10 drives along the trajectory. Note that the processing unit 20A may generate a trajectory in a case where there is no object.

The acquisition unit 20C acquires various information used in the information processing device 20. For example, the acquisition unit 20C acquires a reference trajectory (RT) and information about the object. The information about the object is, for example, a predicted trajectory indicating a predicted value of the trajectory of the object. The reference trajectory is, for example, a trajectory of the mobile object 10 generated by the processing unit 20A as described above.

The reference trajectory is represented by position information representing the route on which the mobile object 10 moves and time information representing the speed or time of the movement. The position information is, for example, a scheduled driving route. Further, the time information is, for example, a speed recommended at each position on the scheduled driving route (recommended speed) or a time to pass each position on the scheduled driving route. As described above, the reference trajectory corresponds to, for example, the trajectory when the mobile object 10 keeps the recommended speed and drives on the scheduled driving route.

The scheduled driving route is a route that the mobile object 10 is scheduled to pass when moving from a certain point to a certain point. For example, the scheduled driving route is a route that the mobile object 10 is scheduled to pass when moving from the current location to the destination.

Specifically, the scheduled driving route is composed of a line passing over a road that is passed when moving from a certain point (for example, the current location of the mobile object 10) to another point (for example, a destination). The line passing over the road is, for example, a line passing through the center of the road to pass (the center of the lane along the moving direction).

Note that the scheduled driving route may include identification information of the road to pass (hereinafter, may be referred to as a road ID).

The recommended speed is a speed recommended when the mobile object 10 moves. For example, the recommended speed is the legal speed and the speed determined from the surrounding road conditions by other systems. The recommended speed may vary depending on the point, or may be constant regardless of the point.

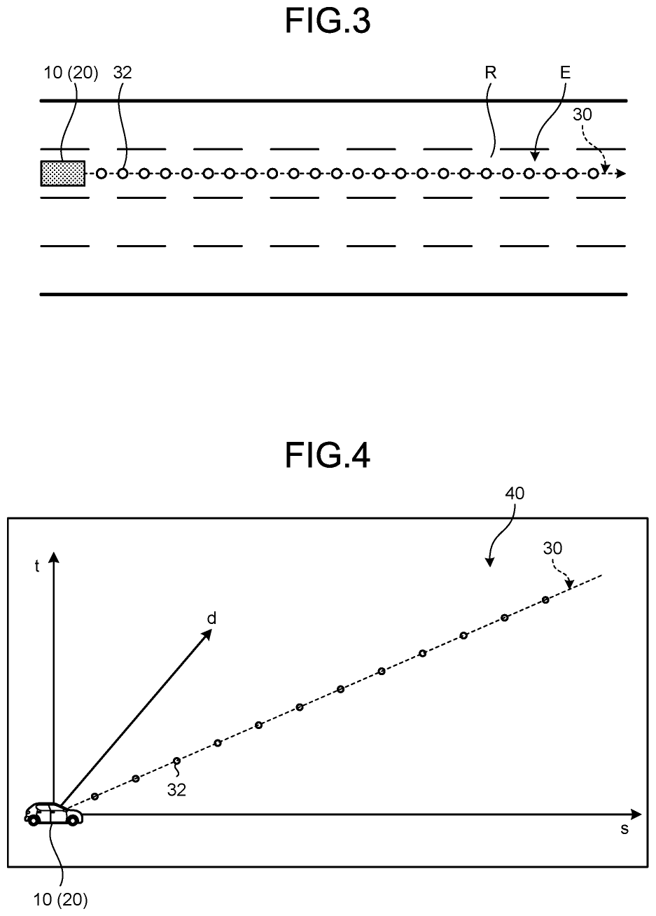

FIG. 3 is a schematic diagram illustrating an example of the reference trajectory 30. The reference trajectory 30 is represented by a line passing through the center of a drivable region E on a road R. The drivable region E is a region in which the mobile object 10 can drive. The drivable region E is, for example, a region along the lane in which the mobile object 10 drives.

In the present embodiment, the case where the reference trajectory 30 is represented by a group of a plurality of reference points 32 (hereinafter referred to as way point (WP) 32) will be described. The WP 32 is a point that specifies the position (corresponding to the position information) and at least one of the scheduled passing time and the scheduled passing speed of the mobile object 10 (corresponding to the time information). The WP 32 may further include the posture of the mobile object 10. Note that the WP 32 may be represented by a vector instead of a point.

The position specified in the WP 32 indicates the position on the map. The position is represented, for example, in world coordinates. Note that the position may be represented by a relative position with respect to the current position of the mobile object 10.

The scheduled passing time specified in the WP 32 represents the time when the mobile object 10 is scheduled to pass the position of the WP 32. The scheduled passing time may be a relative time with respect to a specific time, or may be a time corresponding to a standard radio wave.

The scheduled passing speed specified in the WP 32 represents the scheduled speed when the mobile object 10 passes the position of the WP 32. The scheduled passing speed may be a relative speed with respect to a specific speed or may be an absolute speed.

Returning to FIG. 2, the description will be continued. The generation unit 20D generates a node representing a point used for searching the trajectory of the mobile object 10. In the present embodiment, the generation unit 20D generates a node using one or more avoidance patterns. The avoidance pattern is a pattern indicating one or more operations of the mobile object for avoiding a colliding object. For example, the generation unit 20D generates a plurality of nodes at positions corresponding to the operation indicated by the avoidance pattern to avoid the object (first object) on the reference trajectory (first trajectory) based on one or more avoidance patterns. The details of the avoidance pattern will be described later.

The functions of the generation unit 20D will be further described below. The generation unit 20D receives the reference trajectory 30 to be arranged in the search space and the object information from the acquisition unit 20C.

The object is an object that may hinder the drive of the mobile object 10. The object is, for example, an obstacle. The obstacle is, for example, other mobile objects, living things such as people and trees, and non-living things (e.g., various objects such as signs, signals, guardrails, and the like) placed on the ground. Note that the object is not limited to the obstacle. For example, the object may be a non-obstacle. The non-obstacle is a region where the road surface has deteriorated in the drivable region E. The region where the road surface has deteriorated is, for example, puddles and depressed regions. Further, the non-obstacle may be a driving prohibited region. The driving prohibited region is a region where driving is prohibited, which is represented by road rules. The driving prohibited region is, for example, a region specified by an overtaking prohibition sign.

FIG. 4 is a schematic diagram illustrating the search space 40. The search space 40 is a space represented by a two-dimensional coordinate space (sd coordinate space) and a scheduled passing time axis (t) or a scheduled passing speed axis (v) orthogonal to the two-dimensional coordinate space. In FIG. 4, the scheduled passing time axis (t) is illustrated as an example as a coordinate axis orthogonal to the two-dimensional coordinate space.

The two-dimensional coordinate space is a two-dimensional plane space along the drivable region E (see FIG. 3) of the mobile object 10 moving in the reference trajectory 30. This two-dimensional coordinate space is specified by the s-axis along the moving direction of the mobile object 10 (direction along the reference trajectory, the direction along the road) and the d-axis along the width direction of the mobile object 10. The s-axis and d-axis are arranged orthogonally. Note that the s-axis matches the extension direction of the reference trajectory 30. Further, the width direction is a direction orthogonal to the s-axis.

The scheduled passing time axis (t) orthogonal to the two-dimensional coordinate space (sd coordinate space) is a coordinate axis indicating the scheduled passing time of the mobile object 10.

Note that, as described above, the search space 40 may represent the scheduled passing speed axis (v) as a coordinate axis instead of the scheduled passing time axis (t).

It is sufficient if the generation unit 20D generates the search space 40 according to the specified content of the WP 32 constituting the reference trajectory 30.

For example, it is assumed that the WP 32 constituting the reference trajectory 30 specifies the position and the scheduled passing time. In this case, it is sufficient if the generation unit 20D generates the search space 40 having the two-dimensional coordinate space (sd coordinate space) and the scheduled passing time axis (t) as the coordinate axes. Further, for example, it is assumed that the WP 32 constituting the reference trajectory 30 specifies the position and the scheduled passing speed. In this case, it is sufficient if the generation unit 20D generates the search space 40 having the two-dimensional coordinate space (sd coordinate space) and the scheduled passing speed axis (v) as the coordinate axes.

Note that the generation unit 20D may represent the search space 40 in the xy coordinate space or the xyz coordinate space of the world coordinates instead of the sd coordinate space. In this case, the xy coordinate space is a two-dimensional plane orthogonal to the z-axis direction indicating the vertical direction (elevation).

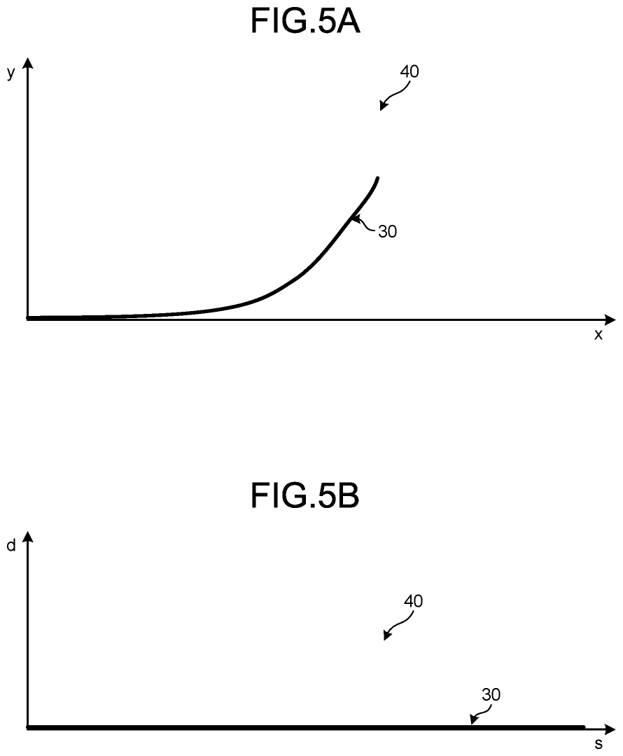

FIGS. 5A and 5B are explanatory diagrams illustrating the two-dimensional coordinate space of the search space 40 in the xy coordinate space and the sd coordinate space, respectively. FIG. 5A is an example in which the two-dimensional coordinate space of the search space 40 is represented by the xy coordinate space and the reference trajectory 30 is arranged. FIG. 5B is an example in which the two-dimensional coordinate space of the search space 40 is represented by the sd coordinate space and the reference trajectory 30 is arranged.

The mobile object 10 does not always drive at the recommended speed on the scheduled driving route. In order to make the mobile object 10 follow the scheduled driving route, for example, the processing unit 20A generates a trajectory in which the mobile object 10 follows the scheduled driving route and drives on the scheduled driving route at a recommended speed after the following (hereinafter referred to as the following trajectory). It is sufficient if the processing unit 20A uses known methods to calculate the following trajectory.

Note that, when realizing lane change, the processing unit 20A generates a following trajectory that follows the scheduled driving route moved to a new lane.

Then, the processing unit 20A determines whether the reference trajectory or the following trajectory collides with the object. In the case of collision, the processing unit 20A generates a trajectory that avoids the object. When the trajectory to avoid the object is not generated, the processing unit 20A calculates an emergency stop trajectory. The emergency stop trajectory is a trajectory for stop at a braking distance. The processing unit 20A can generate the emergency stop trajectory by using a known method (for example, Reference Document 1).

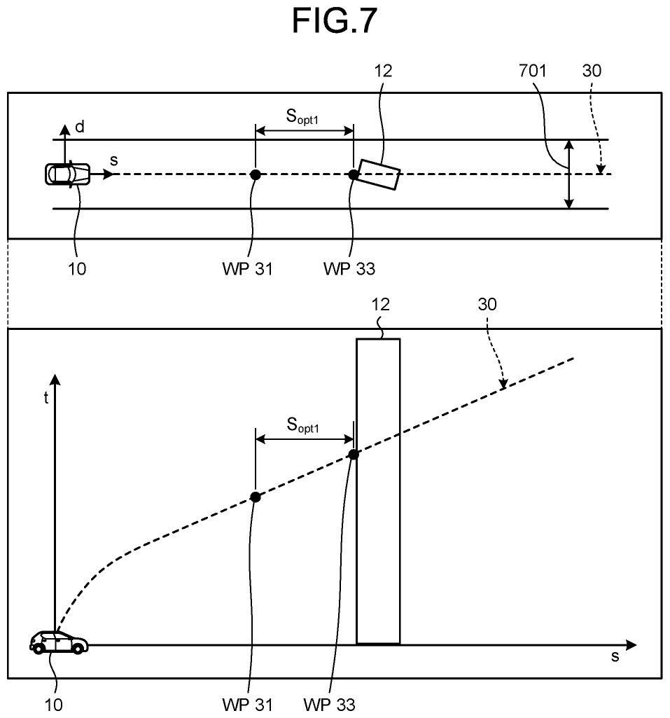

Returning to FIG. 2, the description will be continued. The generation unit 20D calculates the position (collision position) where the reference trajectory or the following trajectory collides with the object. Next, the generation unit 20D acquires the WP that is the closest to the collision position among the WPs on the reference trajectory or the following trajectory. This WP corresponds to a WP 33, which will be described later in FIG. 7 and the like.

Since the WP 33 merely matches a WP on the reference trajectory or following trajectory for the sake of convenience, the collision position may be set to the WP 33.

When the following trajectory is generated and the WP 33 is on the scheduled driving route (when the mobile object 10 follows the scheduled driving route and is driving along the scheduled driving route), the following trajectory is set to the reference trajectory 30.

When the following trajectory is generated and the WP 33 deviates from the scheduled driving route and collides with the object (while the mobile object 10 is following the scheduled driving route), following the scheduled driving route is canceled and a trajectory to avoid the object from the current position of the mobile object 10 is generated. Therefore, the reference trajectory 30 is not changed. The generation unit 20D selects the WP 33 from the unchanged reference trajectory 30.

On the basis of the WP 33, the generation unit 20D determines the node arrangement position (sampling position). In the present embodiment, in order to further reduce the number of nodes, attention is paid to an avoidance pattern peculiar to the mobile object 10 with respect to the object. Then, the node is arranged (generated) only in the region necessary for the avoidance pattern.

As described above, the avoidance pattern may be any pattern as long as it is a pattern indicating one or more operations of the mobile object 10 for avoiding the colliding object. In the following, an example will be described in which four avoidance patterns are used: right overtaking, left overtaking, acceleration/deceleration (acceleration or deceleration) for avoiding collision with the object, and followingfollowing of the object.

The number of avoidance patterns may be one to three, and five or more. For example, right overtaking and left overtaking are examples of patterns indicating overtaking of an object, and only one of them may be used. Further, when, for example, the mobile object 10 is a flying object, when the object is overtaken from other than the left and right, the avoidance pattern of overtaking from a direction other than the left and right (for example, overtaking from above, overtaking from below) may be further used.

The following of the object is an avoidance pattern in which the mobile object 10 drives on the scheduled driving route while maintaining a certain distance from the object. There is a case where the object deviates from the scheduled driving route, such as driving to the right of the lane width, but the mobile object 10 drives on the scheduled driving route.

Note that, in addition to such following of the object, following (following in a broad sense) includes following of a trajectory (route). The following of the trajectory means that, in the case of deviation from a certain trajectory, the mobile object 10 joins this trajectory and then moves along this trajectory. The above-mentioned following trajectory is an example of a trajectory generated for the following of the trajectory.

The acceleration/deceleration for avoiding collision is an avoidance pattern that the mobile object 10 executes at least one of acceleration and deceleration to avoid collision with other mobile objects (such as other vehicles) at, for example, turning right at an intersection and lane merging. In this avoidance pattern as well, the mobile object 10 drives on the scheduled driving route in the same manner as the following of the object.

On the other hand, the avoidance pattern of lane merging is not defined. In the case of lane merging, the reference trajectory has moved to the new lane. By applying the above four avoidance patterns to the reference trajectory, a lane merging trajectory can be generated.

Next, the operation for realizing the avoidance pattern is defined. The avoidance pattern can be expressed by a combination of at least a part of the following four operations.

(A1) Driving on the reference trajectory (RT driving)

(A2) Deviation from the reference trajectory (RT deviation)

(A3) Merging of a new reference trajectory (new RT merging)

(A4) Driving on a new reference trajectory (new RT driving)

The new reference trajectory is a trajectory in which the reference trajectory is offset (shifted) in the time-axis direction (t-axis direction). The reason why the new reference trajectory is needed is that when deviation from the reference trajectory occurs, the time to reach the position of a certain WP 32 after the deviation becomes later or earlier than the WP 32.

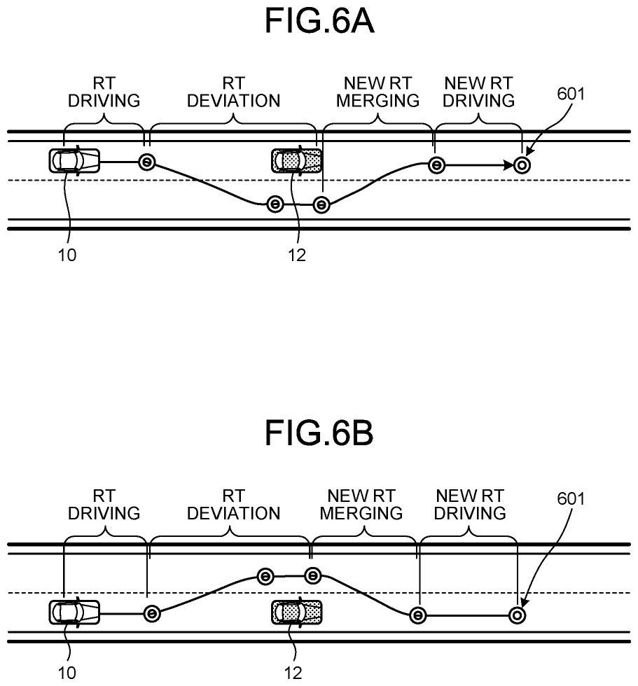

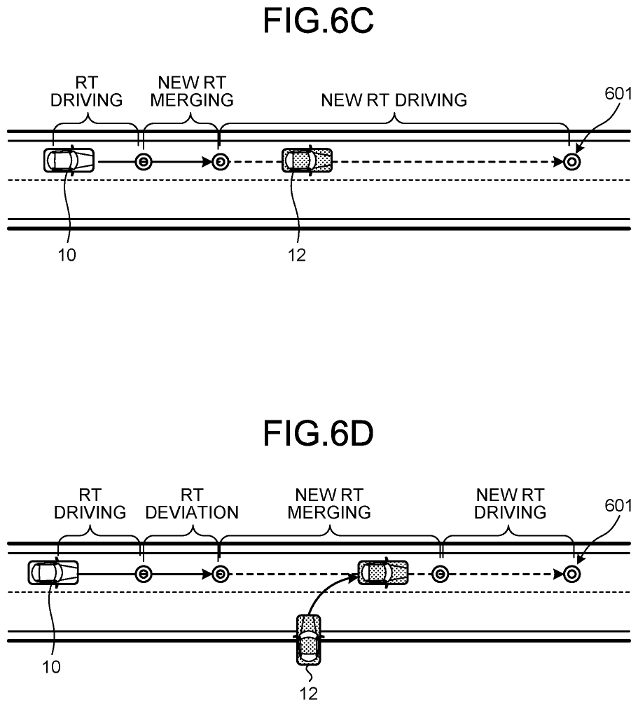

The operation constituting each avoidance pattern will be described with reference to FIGS. 6A to 6D. FIG. 6A is a diagram illustrating an example of an operation constituting right overtaking. FIG. 6B is a diagram illustrating an example of an operation constituting left overtaking. In FIGS. 6A and 6B, an example is illustrated in which the mobile object 10, which is a vehicle, overtakes an object 12, which is another vehicle, and reaches a goal 601. The goal 601 indicates, for example, a position to be reached after a certain period of time has elapsed from the start of the search. In this way, the search for the trajectory can be executed in units of a fixed time.

As illustrated in FIGS. 6A and 6B, right overtaking and left overtaking include operations executed in the order described below.

(A1) Driving on the reference trajectory (RT driving) until a point before reaching the object

(A2) Deviating from the reference trajectory in the d-axis direction and time-axis direction (t-axis direction) for overtaking at the point before reaching the object, completing the deviation immediately beside the object, and moving in parallel with the axis of the extension direction of the reference trajectory until overtaking the object (RT deviation)

(A3) Overtaking the object and then merge the new reference trajectory (new RT merging)

(A4) Driving on the new reference trajectory (new RT driving)

As described above, the operations that constitute right overtaking and left overtaking are common, and they are different as to whether to overtake from the right side or the left side of the object. Note that overtaking the object means, for example, reaching ahead (or front) of the object in the moving direction of the mobile object 10.

As illustrated in FIG. 6C, following of the object includes operations executed in the order described below. The new reference trajectory is a trajectory in which the trajectory of the object is offset by a certain distance in the extension direction.

(A1) Driving on the reference trajectory (RT driving) until a point before reaching the object

(A3) Merging of a new reference trajectory (new RT merging)

(A4) Driving on the new reference trajectory (new RT driving)

As illustrated in FIG. 6D, the acceleration/deceleration for avoiding collision includes operations executed in the order described below.

(A1) Driving on the reference trajectory (RT driving) until a point before reaching the object

(A2) Deviation in the time-axis direction of the reference trajectory at the point before reaching the object (RT deviation)

(A3) Merging the new reference trajectory after deviation (new RT merging)

(A4) Driving on the new reference trajectory (new RT driving)

The generation unit 20D calculates the position of the node corresponding to each operation for each operation included in the avoidance pattern. The generation unit 20D calculates the position of the node, for example, using the position of the object 12 as a base point.

Hereinafter, a method of calculating the position of the node in each operation will be described. Note that as for the above-mentioned A1 (driving on the reference trajectory), it is sufficient if driving is performed on the reference trajectory 30 that has already been obtained, and the generation unit 20D does not need to generate a new node.

A method of calculating the position of the node for A2 (deviation from the reference trajectory) described above will be described. As a prerequisite for this description, it is assumed that the mobile object 10 is driving on the reference trajectory 30. The node for deviation includes a deviation start node, a deviation end node, and a parallel driving completion node.

In this way, a plurality of types of nodes may be generated with respect to one operation. The generation unit 20D generates a plurality of types of nodes in a predetermined order. For example, the generation unit 20D generates the nodes in the order of the deviation start node, the deviation end node, and the parallel driving completion node.

FIG. 7 is a diagram illustrating an example of a method of generating a WP (WP 31) corresponding to the deviation start node. The deviation start node is a node at which the deviation from the reference trajectory 30 starts. Arrow 701 represents the width of the drivable region. In FIG. 7, the object 12 is a stationary body. Since it is stationary, the position of the object 12 in the sd coordinate space is constant regardless of the time t.

On the other hand, when the object 12 is a mobile object (a mobile object different from the mobile object 10), the position of the mobile object in the sd coordinate space changes discretely depending on the time t. Specifically, the mobile object stops at the position of t from t to t+Δt, teleports to the position of t+Δt at t+Δt, and stops at the position of t+Δt from t+Δt to t+2Δt. The symbol Δt is set to an interval so that the mobile object 10 does not pass through the object 12 when determining the collision. Even when the object 12 is a mobile object, the method of generating the deviation start node is the same as the case of the stationary body. Therefore, the description for the mobile object will be omitted.

The deviation start node is generated at a position away from the WP 33 by Sₒₚₜ₁. As described above, the WP 33 is a WP that is the closest to the collision position among WPs on the reference trajectory 30. It is sufficient if Sₒₚₜ₁ is stored in the storage unit 20B in advance by, for example, operating the input device 10C by the user.

For example, the storage unit 20B stores a look-up table in which the speed of the mobile object 10 and the value of Sₒₚₜ₁ are associated with each other. The generation unit 20D obtains Sₒₚₜ₁ corresponding to the current speed of the mobile object 10 from such a look-up table, and generates a deviation start node (WP 31) from the obtained value of Sₒₚₜ₁ and the position of the WP 33.

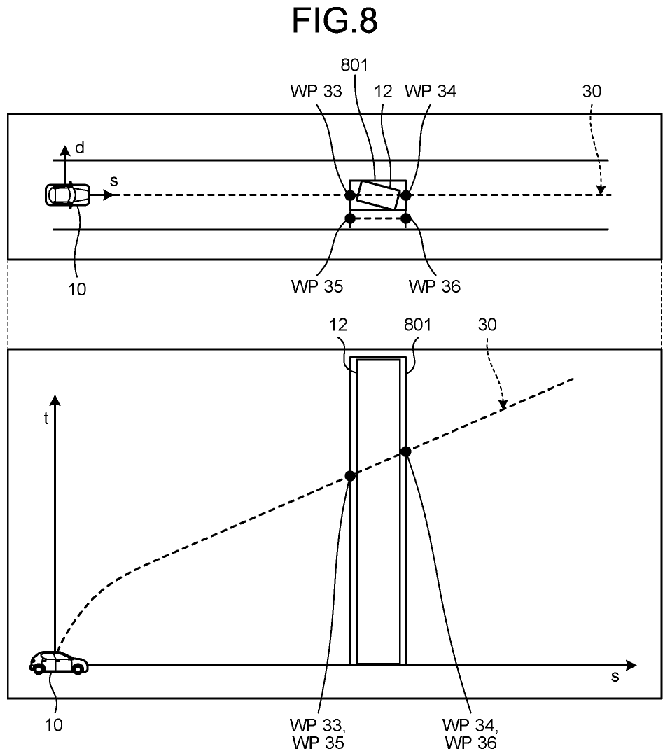

When different values of Sₒₚₜ₁ are used for each avoidance pattern, a look-up table in which the information that specifies the avoidance pattern is further associated may be used. Further, when sharing a look-up table for obtaining the value of Sₒₚₜ₂ used for determining a merging complete node (WP 37) described later, a look-up table in which specific information for specifying which to use as the object: the deviation start node or the deviation end node is further associated may be used. The specific information is, for example, information indicating whether the WP that is the closest to the position where the reference trajectory 30 collides with the object 12 (vehicle and the like) is the WP 33, which is a WP on the near side in the moving direction, or the WP 34, which is a WP on the far side in the moving direction (see FIG. 8).

Further, instead of the speed of the mobile object 10, the avoidance method (slow avoidance, quick avoidance) may be stored in the look-up table. In this case, the generation unit 20D obtains, for example, Sₒₚₜ₁ corresponding to the avoidance method input by the user, and generates the deviation start node (WP 31) from the value of obtained Sₒₚₜ₁ and the position of the WP 33.

Next, an example of a method of generating the deviation end node will be described. The deviation end node is a node at which the deviation ends. The method of generating the deviation end node differs depending on the avoidance pattern. FIG. 8 is a diagram illustrating an example of a method of generating a WP (WP 35) corresponding to the deviation end node in overtaking.

A rectangular parallelepiped 801 circumscribing the object 12 is set as intermediate information for generating the WP 35 and a WP 36 (parallel driving completion node) described later. The reason for setting the rectangular parallelepiped 801 is to calculate the trajectory for driving in parallel with the s-axis (driving along the road) so that the mobile object 10 does not disturb the traffic flow.

The position of the vertex of the rectangular parallelepiped 801 in the d-axis direction is a position circumscribing the object 12. The positions of the vertices of the rectangular parallelepiped 801 in the s-axis direction are the WP 33 and the WP 34. The position of the vertex of the rectangular parallelepiped 801 in the t-axis direction is the same as the position of the object 12 in the t-axis direction. Here, the WP 34 is the WP on the reference trajectory 30, and is the WP closest to the position where there is no collision with the object 12.

The WP is represented by coordinates (s,d,t) of the search space 40 having the two-dimensional coordinate space (sd coordinate space) and the time axis (t) as coordinate axes. Further, the WP 33 and the WP 34 are represented by the following formulae (1) and (2).

WP 33=(s_{WP33},d_{WP33},t_{WP33}) (1)

WP 34=(s_{WP34},d_{WP34},t_{WP34}) (2)

The position of the deviation end node WP 35 in overtaking is set to be the same as that of the WP 33 on the s-axis and t-axis, and set to the midpoint d_{WP35} between the end of the rectangular parallelepiped 801 and the end of the drivable region on the d-axis. That is, the WP 35 is expressed by the following formula (3).

WP 35=(s_{WP33},d_{WP35},t_{WP33}) (3)

Next, a method of generating a deviation end node in acceleration/deceleration for avoiding collision will be described. In acceleration/deceleration for avoiding collision, the mobile object 10 does not deviate in the d-axis direction. Therefore, the position of the deviation end node is set to be the same as that of the WP 33. In order to accelerate or decelerate, it is necessary to further offset the WP 33 in the t-axis direction. This offset will be described later.

Next, a method of generating a parallel driving completion node will be described. The parallel driving completion node is a node arranged at a position where the parallel driving completes. Parallel driving means that when the avoidance pattern is overtaking, the mobile object 10 drives along the road from the WP 35 to overtake the object 12 and at the same speed as the reference trajectory 30 (for example, the speed at the WP 35). The number of nodes can be reduced by limiting the driving of the mobile object 10 to a constant speed along the road.

The WP corresponding to the parallel driving completion node is referred to as the WP 36 below. FIG. 8 illustrates an example of the WP 36. The coordinates of the parallel driving completion node WP 36 are expressed by the following formula (4).

WP 36=(s_{WP34},d_{WP35},t_{WP34}) (4)

Since the WP 31, the WP 35, and the WP 36 are heuristically defined, there may be more suitable nodes than the nodes corresponding to these WPs. Therefore, the generation unit 20D arranges new nodes around these WPs (nodes).

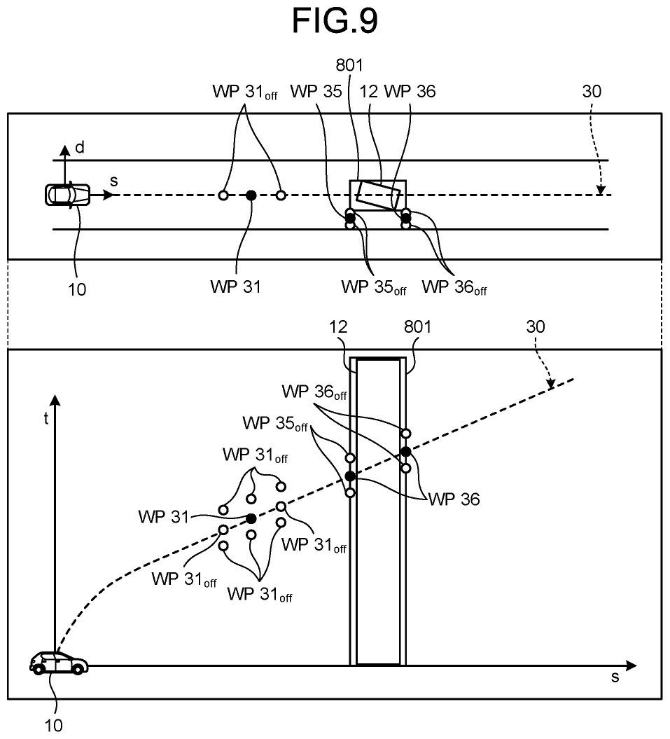

FIG. 9 is a diagram illustrating an example of WPs arranged around the WP 31, the WP 35, and the WP 36. WPs arranged around the WP 31, the WP 35, and the WP 36 are represented by WP 31_{off}, WP 35_{off}, and WP 36_{off}, respectively. The direction in which the new WPs are arranged differs depending on the type of operation (A1 to A4) included in the avoidance pattern.

The WP 31 is expressed by the following formula (5).

WP 31=(s_{WP31},d_{WP31},t_{WP31}) (5)

Since the WP 31_{off} drives (A1) on the reference trajectory 30 until the start of the deviation (A2) from the reference trajectory, the WP 31 is arranged at the position offset in the s-axis direction and the position offset in the t-axis direction. A WP offset in the t-axis direction from the reference trajectory 30 means acceleration or deceleration. The WP 31_{off} is expressed by the following formula (6).

WP 31_{off}=(s_{WP31}+nₛ₃₁×ps_{wp31off},d_{WP31},t_{WP31}+nₜ₃₁×pt_{wp31off}) (6)

The symbols ps_{wp31off}, pt_{wp31off} are offset intervals in the s-axis direction and the t-axis direction. The symbols nₛ₃₁, nₜ₃₁ are integers determined according to the number of offsets. The offset interval and the number of offsets can be configured to be acquired from, for example, a look-up table. When generating one WP 31_{off} each before and after the positon of the WP 31 as the center in the s-axis direction and generating one WP 31_{off} each before and after the positon of the WP 31 as the center in the t-axis direction, the nₛ₃₁, nₜ₃₁ take values illustrated, for example, in the combinations described below. FIG. 9 illustrates an example of eight WPs 31_{off} generated according to these values.

(nₛ₃₁,n_{L31})=(−1,−1),(−1,0),(−1,1),(0,−1),(0,1),(1,−1),(1,0),(1,1)

For the WP 35 and the WP 36 after deviating from the reference trajectory (A2), WPs to be newly arranged are determined as described below.

The WP 35_{off} is arranged at a position where the WP 35 is offset in the d-axis direction and a position where the WP 35 is offset in the t-axis direction. The reason for arranging in the d-axis direction is to adjust the offset amount in the d-axis direction when driving in parallel with the object 12. The reason for arranging in the t-axis direction is to accelerate or decelerate the mobile object 10. The reason for not arranging in the s-axis direction is to save the number of nodes.

The WP35_{off} is expressed by the following formula (7).

WP 35_{off}=(s_{WP33},d_{WP35off},t_{WP35off}),

d_{WP35off}=d_{WP35}+n_{d35}×pd_{WP35off},

t_{WP35off}=t_{WP33}+nₜ₃₅×pt_{WP35off} (7)

The symbols pd_{WP35off}, pt_{WP35off} are offset intervals in the d-axis direction and the t-axis direction. The symbols n_{d35}, nₜ₃₅ are integers determined according to the number of offsets. When generating one WP 35_{off} to the front one to the back in the d-axis direction and one to the front and one to the back in the t-axis direction about the position of the WP 35, the n_{d35}, nₜ₃₅ take values illustrated, for example, in the combinations described below.

(n_{d35},n_{L35})=(−1,−1)(−1,0),(−1,1),(0,−1)(0,1),(1,−1),(1,0),(1,1)

The WP 36_{off} has the same d-coordinate as the WP35_{off} and the same s-coordinate as the WP 36. The WP 36_{off} is expressed by the following formula (8). The nₜ₃₆ is an integer determined according to the number of offsets.

WP36_{off}=(s_{WP34},d_{WP35off},t_{WP34}+nₜ₅₆+nₜ₃₆×pt_{WP35off}) (8)

Next, a method of calculating the position of the node for the above A3 (merging of the new reference trajectory) will be described. The node for A3 includes the merging complete node. The merging complete node is a node that completes merging of the new reference trajectory.

Prior to the calculation of the merging complete node, a method of setting a new reference trajectory will be described. The new reference trajectory is set to eliminate the deviation in the time direction caused by the deviation from the reference trajectory.

The base point for calculating the new reference trajectory differs depending on the avoidance pattern. In the case of overtaking, one node selected from the parallel driving completion nodes WP 36 and the WPs 36_{off} will be the base point. In the case of following of the object, one node selected from the deviation start node WP 31 and the WPs 31_{off} will be the base point. In the case of acceleration/deceleration for avoiding collision, one node selected from the deviation end node WP 35 and the WPs 35_{off} will be the base point.

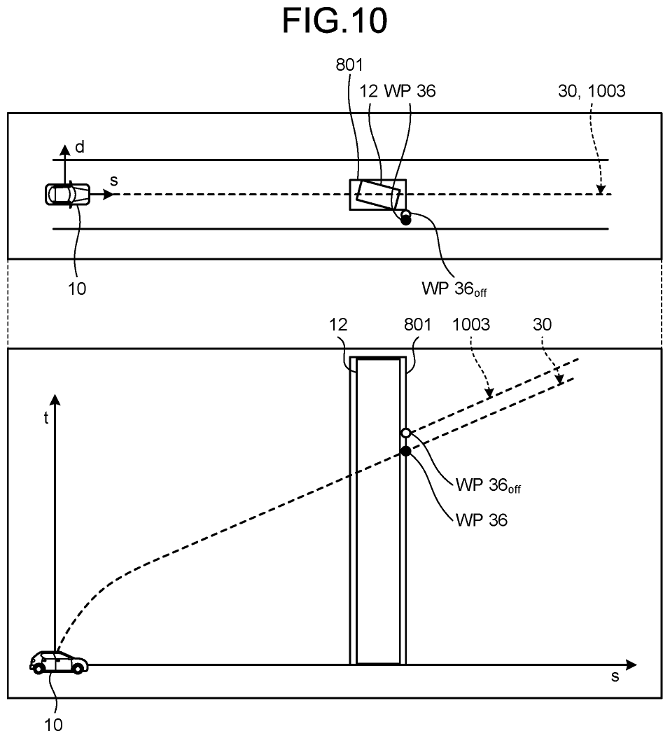

The new reference trajectory calculation method is common to the avoidance patterns of overtaking and acceleration/deceleration for avoiding collision. The case of overtaking will be described below as an example. FIG. 10 is a diagram illustrating an example of a new reference trajectory in this case.

The coordinates of the WP 32 included in the reference trajectory 30 are expressed by the following formula (9).

WP 32=(s_{WP32},d_{WP32},t_{WP32}) (9)

When setting a new reference trajectory by using the WP 36_{off} as the base point, the coordinates of a WP 32, of the new reference trajectory are expressed by the following formula (10).

WP32ₙ=(s_{WP32},d_{WP32},t_{WP32}+nₜ₃₆×pt_{WP35off}) (10)

As illustrated in the formula (10), the d-coordinates of the WP 32ₙ is the same as the reference trajectory, not the same as the WP 36_{off}. Note that when the WP 36 is used as the base point, the reference trajectory and the new reference trajectory are the same because they are not offset in the time direction.

The new reference trajectory in following of the object is a trajectory offset by a certain distance in the extension direction from the trajectory of the object. The generation unit 20D uses a known method (e.g., “M. Werling et al., “Optimal Trajectory Generation for Dynamic Street Scenarios in a Frenet Frame”, Proceedings—IEEE International Conference on Robotics and Automation, June 2010”) to calculate a s-coordinate s_{WP32int}(t) at time t of the new reference trajectory in the following of the object, for example, according to the formula (11) below.

s_{WP32nf}(t)=s₁ᵥ(t)−(D₀+τ×vs₁ᵥ(t)) (11)

The symbol s₁ᵥ(t) is the position of the object 12, the symbol vs₁ᵥ(t) is the speed of the object 12, and the symbols D₀ and τ are constants. Note that the d-coordinate of the new reference trajectory in following of the object is the same as the original reference trajectory.

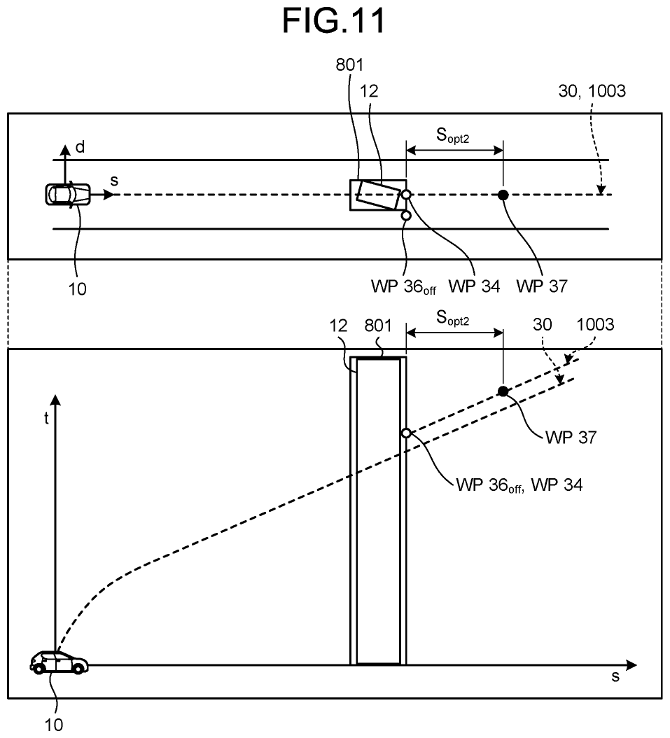

The generation unit 20D generates the merging complete node WP 37, which is a node that merges this new reference trajectory. The method of generating the WP 37 can be the same as the method of generating the deviation start node WP 31. For example, the generation unit 20D generates a merging complete node at a position away from the WP 34 by Sₒₚₜ₂. Similar to Sₒₚₜ₁, Sₒₚₜ₂ can be obtained from, for example, a look-up table. FIG. 11 is a diagram illustrating an example of a method of generating the merging complete node WP 37.

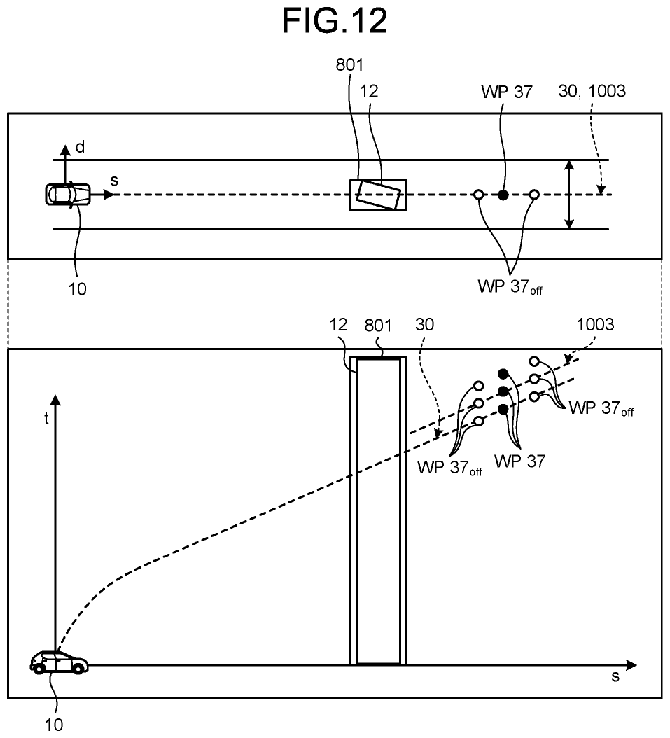

Then, the generation unit 20D arranges a node WP 37_{off} around the merging complete node WP 37. The arrangement direction of the WP 37_{off} is the s-axis direction and the t-axis direction similar to the node WP 31_{off} arranged around the deviation start node WP 31. FIG. 12 is a diagram illustrating an example of the WP 37_{off} arranged around the WP 37.

As for the above A4 (driving on the new reference trajectory), it is sufficient if driving is performed on the new reference trajectory, and the generation unit 20D does not need to generate a new node.

Returning to FIG. 2, the calculation unit 20E, the addition unit 20F, the search unit 20G, the selection unit 20H, and the output control unit 20I will be described below.

The calculation unit 20E calculates the cost (edge cost) for each of the generated nodes. For example, for each generated node, the calculation unit 20E calculates the cost of the trajectory from the previous node to the node. In the following, the trajectory connecting the two nodes may be called an edge. The previous node is a node generated one before in the order described below.
Order of operation
When multiple types of nodes are generated for a certain operation, the order of node generation within the operation

In the case of the first operation, the previous node is, for example, the route node indicating the current position of the mobile object 10. In the case of the second and subsequent operations, the previous node is, for example, the node of the previous operation. The details of the route cost will be described later. When a plurality of types of nodes are generated for an operation, the previous node is the node generated in the previous generation order set in this operation.

First, the calculation unit 20E connects the previous node and the current node. For example, the calculation unit 20E connects one node among a plurality of nodes including the deviation start node WP 31 and the WP 31_{off} and one node among a plurality of nodes including the deviation end node WP 35 and the WP35_{off}. In principle, the calculation unit 20E connects all combinations of the two nodes. However, when the calculation unit 20E connects one of a plurality of nodes including the deviation end node WP 35 and the WP 35_{off} and one of a plurality of nodes including the parallel driving completion node WP 36 and the WP 36_{off}, only two nodes with the same d-coordinate and the same t-coordinate offset are connected. This is to allow the mobile object 10 to drive along the road at the same speed as the reference trajectory.

Next, the calculation unit 20E calculates the cost of the node (edge cost). The cost of the node is a value obtained by evaluating the edge connecting the previous node and the current node from the viewpoint of control, the viewpoint of driving rules, and the viewpoint of collision with the object.

The cost from the viewpoint of control is, for example, a cost based on speed, acceleration, and jerk. The calculation unit 20E calculates the edge cost so that the evaluation is low, for example, in the cases described below.
The acceleration of the mobile object 10 driving on the trajectory exceeds the upper limit.
The jerk of the mobile object 10 driving on the trajectory exceeds the upper limit.
The trajectory length is zero (that is, the speed is zero).

The cost from the viewpoint of driving rules is, for example, a cost based on the amount of deviation from the reference trajectory. The calculation unit 20E calculates the edge cost so that the evaluation is low, for example, in the cases described below.
The mobile object 10 drives in the direction opposite to the driving direction set by the reference trajectory (backward driving).
There is a trajectory outside the drivable region.

The cost from the viewpoint of collision with the object is a cost based on the distance between the trajectory of the mobile object 10 and the trajectory of the object 12. The calculation unit 20E calculates the edge cost so that the evaluation is low, for example, in the cases described below.
The trajectory of the mobile object 10 and the trajectory of the object 12 collide with each other.

The addition unit 20F adds a node to the search space with reference to the calculated edge cost. For example, the addition unit 20F adds a node whose calculated edge cost satisfies a predetermined condition (first condition) to the search space. The predetermined condition is, for example, a condition indicating that the evaluation is low. The condition indicating that the evaluation is low is, for example, a condition indicating that the edge cost is larger than a threshold value (the evaluation is low).

The search unit 20G searches for a trajectory in which the mobile object avoids the object by using the search space to which the node is added. For example, the search unit 20G searches for a trajectory candidate whose route cost is smaller than that of another trajectory candidate among a plurality of trajectory candidates connecting a plurality of nodes added to the search space for each avoidance pattern. A trajectory candidate whose cost is smaller than that of another trajectory candidate is, for example, a trajectory candidate having the lowest cost.

First, the search unit 20G sets a route node at the current position of the mobile object 10. The search unit 20G determines the operation to be executed first among the operations for realizing the avoidance pattern for each avoidance pattern. Nodes are generated by the generation unit 20D for the determined operation, and among the nodes generated, the node that satisfies the condition is added to the search space by the addition unit 20F.

The search unit 20G calculates the route cost of the added node. The route cost is the sum of the edge costs from the route node to the added node. The route from the route node to the added node shall be the route with the lowest route cost. The search unit 20G stores the route with the lowest route cost. Then, when the processing up to A4 (driving on the new reference trajectory), which is the last operation of the avoidance pattern, is ended, the search for the avoidance pattern is ended. The trajectory from the route node used in the first operation to the last node for the last operation is a trajectory candidate for executing this avoidance pattern.

The search unit 20G also executes a search for the remaining avoidance patterns. Trajectory candidates are selected for each avoidance pattern.

While searching for a trajectory candidate (second trajectory) of a certain avoidance pattern, the trajectory candidate can collide with a new object (second object). In this case, collision can be avoided by executing a new avoidance pattern for the object. Therefore, the search unit 20G stops searching for the avoidance pattern when the edge costs of all the trajectories do not satisfy the condition. Then, when there is one or more trajectories that collide with the second object, the trajectory candidates of the avoidance pattern are recursively searched from the node that is the starting point of the colliding trajectory.

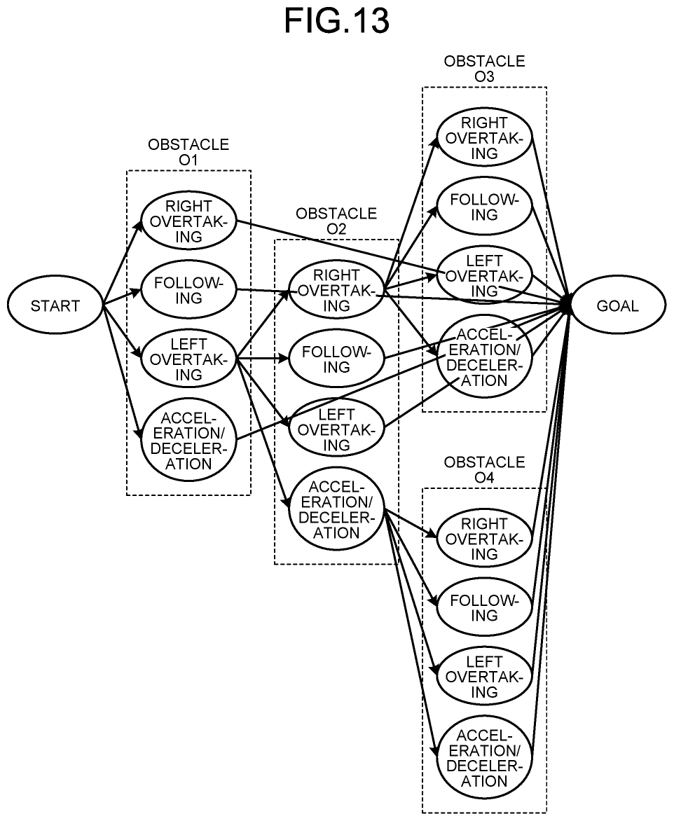

FIG. 13 is a conceptual diagram illustrating a recursive search for trajectory candidates. For example, when searching for a trajectory candidate for left overtaking of an obstacle O1, collision of an obstacle O2 is detected. In this case, the search unit 20G recursively searches for trajectory candidates for avoiding the collision of the obstacle O2. When it is detected that an obstacle O3 or O4 further collides during this search, the search unit 20G further recursively searches for a trajectory candidate for avoiding the collision of the obstacle O3 or O4.

The search unit 20G may stop the search for reasons other than collision. For example, the search unit 20G determines that the search is stopped when the edge costs of all the nodes included in the search space satisfy a predetermined condition (second condition). The predetermined condition is, for example, a condition indicating that the edge cost is larger than the threshold value (evaluation is low).

When the search is stopped, the generation unit 20D stops subsequent node generation. That is, the generation unit 20D stops the generation of the node for the operation in which the node is not generated. Since the generation of unnecessary nodes can be avoided, the time required to generate the trajectory can be reduced.

Note that some or all of the functions of the acquisition unit 20C, the generation unit 20D, the calculation unit 20E, and the addition unit 20F may be provided in the search unit 20G.

Returning to FIG. 2, the description will be continued. The selection unit 20H selects a trajectory candidate whose route cost is smaller than that of another trajectory candidate from among one or more trajectory candidates searched for each avoidance pattern. Further, the selection unit 20H generates a curved route using the selected trajectory candidate.

For example, the selection unit 20H compares the route costs of the searched trajectory candidates for each avoidance pattern, and selects the trajectory candidate having the lowest route cost. The selection unit 20H reversely traces from the last node of the selected trajectory candidate to the route node to obtain a node sequence (route). The selection unit 20H generates a curved route by acquiring and connecting the trajectory connecting each node included in the node sequence.

Further, the selection unit 20H also acquires an avoidance pattern corresponding to the selected trajectory candidate.

Note that, in some cases, the route cost of the trajectory candidate that follows the object 12, which is a stationary object, is the lowest. When the mobile object 10 follows a stationary object, it stops before reaching the original goal. The reason for stopping is that the new reference trajectory is calculated by the offset from the stationary object, and the goal of the new reference trajectory is set before the original goal.

Even when the route cost of the trajectory candidate following the object 12, which is a stationary object, is minimized, it is desirable that the selection unit 20H does not select this trajectory candidate. Therefore, the selection unit 20H acquires the speed of the object 12, and when the speed is zero, selects the trajectory candidate having the lowest route cost among the trajectory candidates that have reached the original goal.

Returning to FIG. 2, the description will be continued. The output control unit 20I outputs output information indicating the curved route generated by the selection unit 20H.

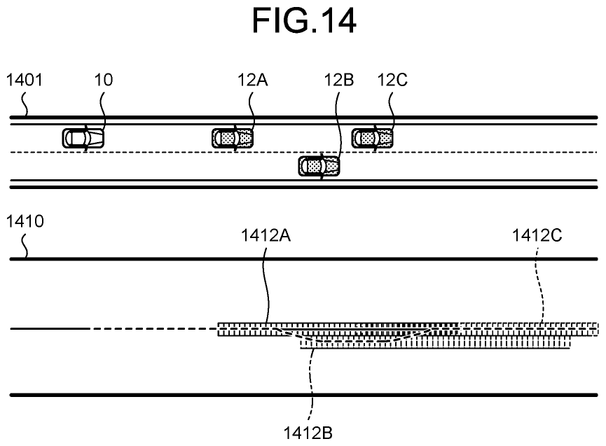

The output control unit 20I further outputs an avoidance pattern. For example, the output control unit 20I displays the avoidance pattern on the display 10E. FIG. 14 is a diagram illustrating an output example of the avoidance pattern displayed on the display 10E.

FIG. 14 illustrates an example of an assumed movement situation 1401 of the mobile object 10 and an avoidance pattern 1410 displayed for this movement situation 1401. The broken line in the avoidance pattern 1410 indicates the curved route when following a mobile object 12C after overtaking a mobile object 12A from the right and returning to the scheduled driving route. A rectangle 1412A, a rectangle 1412B, and a rectangle 1412C indicate expected loci of the mobile object 12A, a mobile object 12B, and the mobile object 12C, respectively. Moreover, the avoidance pattern name may be displayed along the curved route.

Further, the output control unit 20I may control the speaker 10F so as to output a sound indicating an avoidance pattern. Further, the output control unit 20I may output the avoidance pattern to the external device via the communication unit 10D. Further, the output control unit 20I may store the output information in the storage unit 20B.

The output control unit 20I outputs output information indicating the curved route to the power control unit 10G that controls the power unit 10H of the mobile object 10.

In detail, the output control unit 20I outputs the curved route to at least one of the power control unit 10G and the output unit 10A.

First, a case where the output control unit 20I outputs a curved route to the output unit 10A will be described. For example, the output control unit 20I displays output information including one or more of the avoidance pattern name and the curved route on the display 10E. Further, the output control unit 20I may control the speaker 10F so as to output a sound indicating a curved route. Further, the output control unit 20I may output information indicating one or more of the avoidance pattern name and the curved route to the external device via the communication unit 10D. Further, the output control unit 20I may store the output information in the storage unit 20B.

Next, a case where the output control unit 20I outputs the output information indicating the curved route to the power control unit 10G will be described. In this case, the power control unit 10G controls the power unit 10H according to the curved route received from the output control unit 20I.

For example, the power control unit 10G uses a curved route to generate a power control signal for controlling the power unit 10H, and controls the power unit 10H. The power control signal is a control signal for controlling a drive unit of the power unit 10H that drives regarding the driving of the mobile object 10. The power control signal includes a control signal for adjusting the steering angle, the accelerator amount, and the like.

Specifically, the power control unit 10G acquires the current position, posture, and speed of the mobile object 10 from the sensor 10B.

Then, the power control unit 10G uses such information acquired from the sensor 10B and the curved route to generate a power control signal so that the deviation between the curved route and the current position of the mobile object 10 becomes zero, and outputs it to the power unit 10H.

As a result, the power control unit 10G controls the power unit 10H (steering of the mobile object 10, engine, and the lie) so as to drive along the curved route. Therefore, the mobile object 10 drives along the route corresponding to the curved route.

Note that at least a part of the processing of generating the power control signal from the curved route may be performed on the output control unit 20I side.

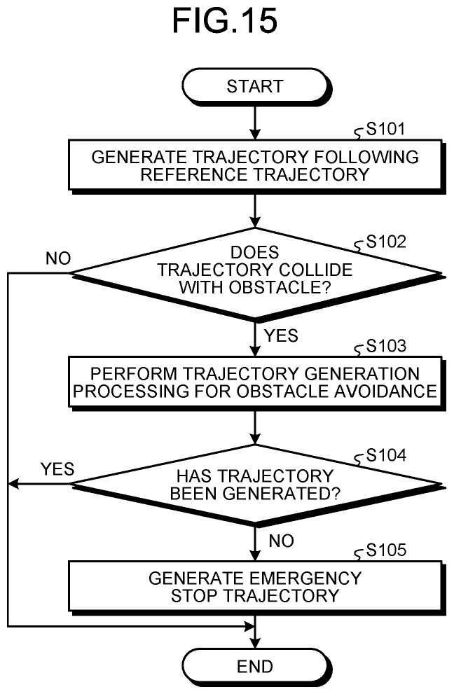

Next, the procedure of information processing executed by the processing unit 20A will be described. FIG. 15 is a flowchart illustrating an example of the trajectory generation processing. A case where the object 12 is an obstacle will be described below as an example. The trajectory generation processing is processing of generating a trajectory of the mobile object 10 according to a reference trajectory. When the reference trajectory collides with an obstacle, a trajectory that avoids the obstacle is generated. The trajectory generation processing is executed, for example, every time a certain period of time elapses in order to respond to changes in the surrounding situation.

For example, the processing unit 20A generates a trajectory that follows the reference trajectory acquired by the acquisition unit 20C (Step S101). The processing unit 20A determines whether or not the reference trajectory collides with an obstacle (Step S102). When the reference trajectory does not collide with the obstacle (Step S102: No), the processing unit 20A ends the processing.

Note that the mobile object 10 is controlled to drive according to the trajectory generated in Step S101. Further, as described above, the trajectory generation processing is executed every time a certain period of time elapses, and the mobile object 10 drives according to the generated trajectory.

When the reference trajectory collides with the obstacle (Step S102: Yes), the trajectory generation processing for avoiding the obstacle is executed (Step S103). Details of the trajectory generation processing for avoiding the obstacle will be described later.

The processing unit 20A determines whether or not the trajectory has been generated by the trajectory generation processing for avoiding the obstacle (Step S104). When no trajectory is generated (Step S104: No), the processing unit 20A generates an emergency stop trajectory (Step S105). The emergency stop trajectory is a trajectory for stopping the mobile object 10 to avoid a collision with the obstacle or the like. The mobile object 10 is controlled to make an emergency stop according to the emergency stop trajectory.

When the trajectory is generated (Step S104; Yes), the processing unit 20A ends the trajectory generation processing. The mobile object 10 is controlled to drive according to the trajectory generated in Step S103.

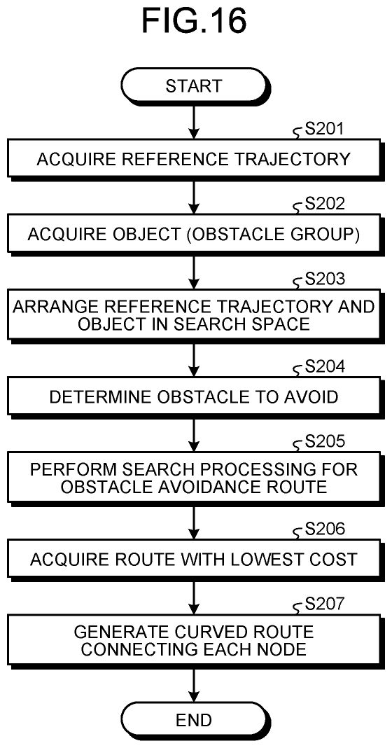

Next, the trajectory generation processing for avoiding the obstacle in Step S103 will be described. FIG. 16 is a flowchart illustrating an example of the trajectory generation processing for avoiding the obstacle.

The acquisition unit 20C acquires the reference trajectory 30 (Step S201). The acquisition unit 20C acquires the information of the object 12, which is an obstacle group including one or more obstacles (Step S202). The generation unit 20D arranges the reference trajectory 30 and the object 12 in the search space 40 (Step S203).

The processing unit 20A determines an obstacle to avoid (Step S204). For example, the processing unit 20A determines that among the obstacles included in the obstacle group, the obstacle that collides with the reference trajectory 30 is an obstacle to avoid. When a plurality of obstacles can collide with the reference trajectory 30, the processing unit 20A determines the obstacle closer to the mobile object 10 to be an obstacle to avoid.

The processing unit 20A executes the search processing for an avoidance route for the determined obstacle (Step S205). The details of the obstacle avoidance route search processing will be described later.

The selection unit 20H selects the trajectory candidate having the lowest route cost from one or more trajectory candidates searched in the obstacle avoidance route search processing. Then, the selection unit 20H reversely traces from the last node of the selected trajectory candidate to the route node to obtain a node sequence (route) (Step S206). The selection unit 20H generates a curved route by acquiring and connecting the trajectory connecting each node included in the node sequence (Step S207).

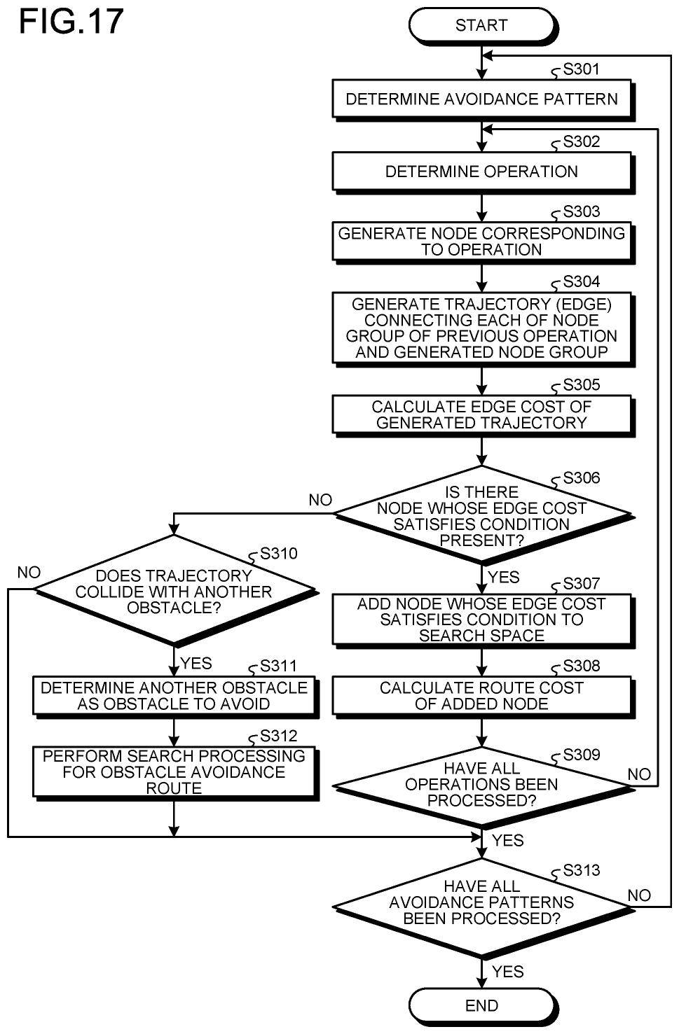

Next, the details of the obstacle avoidance route search processing in Step S205 will be described. FIG. 17 is a flowchart illustrating an example of the obstacle avoidance route search processing.

The generation unit 20D determines the avoidance pattern, which is an object to be searched (Step S301). When using the four avoidance patterns described above, the generation unit 20D determines one from the four avoidance patterns.

The generation unit 20D determines the operation, which is an object to be searched, among the operations included in the determined avoidance pattern (Step S302). As described above, in each avoidance pattern, a plurality of operations are set together with the order of processing. The generation unit 20D determines the object operation according to the order of processing.

The generation unit 20D calculates the position of the node corresponding to the determined operation, and generates the node at the calculated position (Step S303).

The search unit 20G generates a trajectory (edge) connecting the base point node and each node of the node group (Step S304). The base point node is, for example, one of the node group of the previous operation. In the case of the first operation, the base point node is the route node indicating the current position of the mobile object 10.

The calculation unit 20E calculates the cost of the generated edge (edge cost) as the cost for each generated node (Step S305).

The addition unit 20F determines whether or not the generated trajectory (edge) has one or more nodes whose edge cost satisfies the condition (the condition includes the condition indicating that there is no collision with the obstacle) (Step S306). When there is one or more (Step S306: Yes), the addition unit 20F adds a node whose calculated edge cost satisfies the predetermined condition to the search space (Step S307). The search unit 20G calculates the route cost of the added node (Step S308).

The search unit 20G determines whether or not all the operations included in the current avoidance pattern have been processed (Step S309). When all the operations have not been processed (Step S309: No), the processing returns to Step S302, and the processing is repeated for the operations in the next order.

When it is determined in Step S306 that there is not a single node whose edge cost satisfies the condition (Step S306: No), the search unit 20G determines whether one or more of the generated trajectories collide with another obstacle (Step S310). When it is determined that one or more of the generated trajectories collide with another obstacle (Step S310: Yes), the obstacle avoidance route search processing for avoiding this obstacle is recursively executed. That is, the processing unit 20A determines another obstacle, which is determined to collide, as an obstacle to avoid (Step S311). The processing unit 20A executes the search processing for an avoidance route for the determined obstacle (Step S312).

Among the nodes (group) of the start points of the trajectory (edge) generated in Step S304, the node with the lowest route cost becomes the base point node of the recursive search processing.

When all the operations are processed (Step S309: Yes) and when it is determined that there is no collision with another obstacle (Step S310: No), the search unit 20G determines whether or not all the avoidance patterns have been processed (Step S313). When all the avoidance patterns have not been processed (Step S313: No), the processing returns to Step S301 and the processing is repeated for the next avoidance pattern.

When all the avoidance patterns have been processed (Step S313: Yes), the obstacle avoidance route search processing ends.

As described above, the information processing device 20 of the present embodiment generates nodes only in the region required for the avoidance pattern. Therefore, as compared with the conventional method of arranging the nodes in a specific region around the object, it is possible to reduce the processing time and the processing load.

### Variation Example

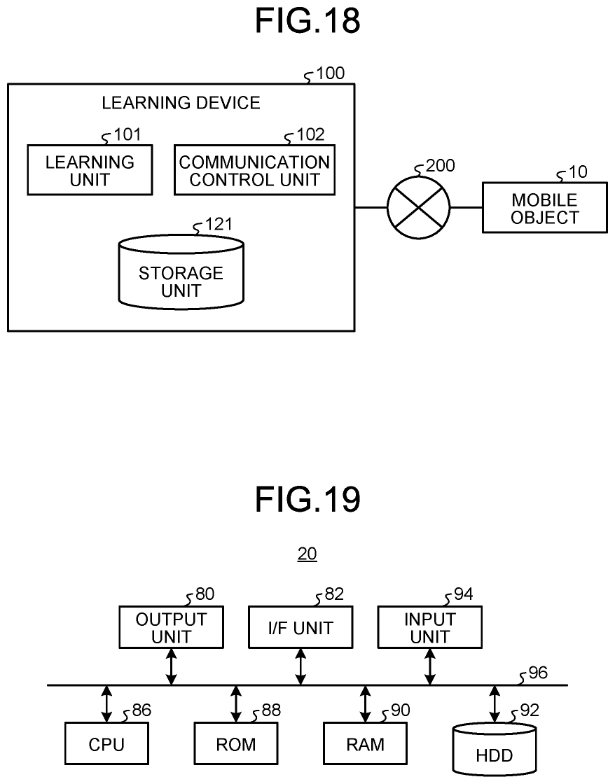

Values of various information for determining the position of the node (for example, Sₒₚₜ₁, Sₒₚₜ₂, offset interval, and the number of offsets) may be determined by prior learning processing. FIG. 18 is a block diagram illustrating a functional configuration example of an information processing system of a variation example configured to execute learning processing. As illustrated in FIG. 18, the information processing system has a configuration in which a learning device 100 and the mobile object 10 are connected via a network 200.

The network 200 may be any form of network such as the Internet and a LAN (local area network). Further, the network may be either a wireless network or a wired network, or may be a mixed network of both.

Since the mobile object 10 is the same as the mobile object 10 of the above embodiment, the same reference numerals are given and the description thereof will be omitted.

The learning device 100 includes a learning unit 101, a communication control unit 102, and a storage unit 121.

The learning unit 101 obtains information used by the mobile object 10 (generation unit 20D) to generate a node by learning. The information used to generate the node is, for example, some or all of Sₒₚₜ₁, Sₒₚₜ₂, the offset interval, and the number of offsets. The learning unit 101 may create a look-up table in which the values obtained by learning are associated with each other.

A case where Sₒₚₜ₁ corresponding to the speed of the mobile object 10 is obtained by learning will be described below as an example. For example, the learning unit 101 learns a machine learning model that inputs a speed and outputs a value of Sₒₚₜ₁. The machine learning model is, for example, a neural network model, but may be a model having any other structure.

The learning method may be any method depending on the machine learning model. For example, supervised learning using learning data, reinforcement learning, and the like can be applied. The learning data is generated based on, for example, log information during driving by a skilled driver.

The communication control unit 102 controls communication with an external device such as the mobile object 10. For example, the communication control unit 102 transmits the information (for example, a look-up table) obtained by the learning unit 101 to the mobile object 10. In the mobile object 10, for example, the communication unit 10D receives the transmitted information such as a look-up table. The generation unit 20D generates a node using the received look-up table.

The storage unit 121 stores various information used in various processing executed by the learning device 100. For example, the storage unit 121 stores information representing a machine learning model, learning data used for learning, information obtained by learning, and the like.

Each of the above units (learning unit 101 and communication control unit 102) is realized by, for example, one or a plurality of processors. For example, each of the above units may be realized by causing a processor such as a CPU to execute a program, that is, by software. Each of the above units may be realized by a processor such as a dedicated integrated circuit (IC), that is, hardware. Each of the above units may be realized by using software and hardware in combination. When a plurality of processors are used, each processor may realize one of the units or may realize two or more of the units.

The storage unit 121 can be composed of any commonly used storage medium such as a flash memory, a memory card, a RAM, an HDD (hard disk drive), and an optical disk.

Next, an example of the hardware configuration of each device (information processing device, learning device) of the above embodiment will be described. FIG. 19 is an example of a hardware configuration diagram of the device of the above embodiment.

The device of the above embodiment includes a control device such as a CPU 86, a storage device such as a read only memory (ROM) 88, a RAM 90, and an HDD 92, an I/F unit 82 that is an interface between various devices, an output unit 80 that outputs various information such as output information, an input unit 94 that accepts operations by the user, and a bus 96 that connects each unit, and has a hardware configuration using a normal computer.

In the device of the above embodiment, the CPU 86 reads a program from the ROM 88 onto the RAM 90 and executes the program, and each of the above functions is realized on the computer.

Note that the program for executing each of the above processing executed by the device of the above embodiment may be stored in the HDD 92. Further, the program for executing each of the above processing executed by the device of the above embodiment may be provided by being incorporated in the ROM 88 in advance.

Further, the program for executing the above processing executed by the device of the above embodiment may be provided as a computer program product by being stored in a storage medium that is readable by a computer in the form of an installable file or executable file, such as a CD-ROM, a CD-R, a memory card, or a digital versatile disk (DVD), flexible disk (FD), or the like. Further, the program for executing the above processing executed by the device of the above embodiment may be provided by being stored on a computer connected to a network such as the Internet and downloaded via the network. Further, the program for executing the above processing executed by the device of the above embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to
generate, on a basis of one or more avoidance patterns each indicating one or more operations of a mobile object for avoiding an object, a plurality of nodes at positions corresponding to the operations indicated by the avoidance patterns to avoid a first object on a first trajectory;
search for, among a plurality of trajectory candidates connecting the plurality of nodes, a trajectory candidate having a moving cost smaller than a moving cost of another trajectory candidate for each of the avoidance patterns; and
select the trajectory candidate having the moving cost smaller than the moving cost of the other trajectory candidate among one or more trajectory candidates searched for each of the avoidance patterns.

2. The information processing device according to claim 1, wherein the one or more hardware processors
generate, in presence of a second object on a second trajectory that is the trajectory candidate the one or more hardware processors searches for, a plurality of nodes at positions corresponding to the operations indicated by the avoidance patterns to avoid the second object on the second trajectory, and
search for the trajectory candidate having the moving cost smaller than the moving cost of the other trajectory candidate among the plurality of trajectory candidates connecting the plurality of nodes generated for the second trajectory.

3. The information processing device according to claim 1, wherein
the one or more hardware processors are further configured to:
calculate a cost of a trajectory from another node to be connected to the node for each of the nodes; and
add the node having the cost satisfying a predetermined first condition to a search space for the searched trajectory candidate, and
the one or more hardware processors search for the trajectory candidate having the moving cost smaller than the moving cost of the other trajectory candidate among the plurality of trajectory candidates connecting the plurality of nodes included in the search space.

4. The information processing device according to claim 1, wherein
the operation includes:
driving on a reference trajectory represented by position information representing a scheduled driving route and time information that is a speed at each position on the scheduled driving route or time to pass each position on the scheduled driving route,
at least one of deviation from the reference trajectory and merging of a new reference trajectory, and
driving on the new reference trajectory.

5. The information processing device according to claim 1, wherein
the avoidance pattern includes:
overtaking of the object,
acceleration or deceleration for avoiding collision with the object, and
following of the object.

6. The information processing device according to claim 1, wherein
the operation includes:
driving on a reference trajectory represented by position information representing a scheduled driving route and time information that is a speed at each position on the scheduled driving route or time to pass each position on the scheduled driving route,
at least one of deviation from the reference trajectory and merging of a new reference trajectory, and
driving on the new reference trajectory, and
overtaking of the object includes:
driving on the reference trajectory until a point before reaching the object,
deviation from the reference trajectory at the point before reaching the object,
merging of the new reference trajectory after reaching ahead of the object in a moving direction, and
driving on the new reference trajectory.

7. The information processing device according to claim 1, wherein
the operation includes:
driving on a reference trajectory represented by position information representing a scheduled driving route and time information that is a speed at each position on the scheduled driving route or time to pass each position on the scheduled driving route,
at least one of deviation from the reference trajectory and merging of a new reference trajectory, and
driving on the new reference trajectory, and
following of the object includes:
driving on the reference trajectory until a point before reaching the object,
merging of the new reference trajectory that is a trajectory obtained by displacing the trajectory of the object in an extension direction along a moving direction of the mobile object, and
driving on the new reference trajectory.

8. The information processing device according to claim 1, wherein
the operation includes:
driving on a reference trajectory represented by position information representing a scheduled driving route and time information that is a speed at each position on the scheduled driving route or time to pass each position on the scheduled driving route,
at least one of deviation from the reference trajectory and merging of a new reference trajectory, and
driving on the new reference trajectory, and
acceleration or deceleration for avoiding collision with the object includes:
driving on the reference trajectory to a point before reaching the object,
deviation from the reference trajectory at the point before reaching the object in a time-axis direction, merging of the new reference trajectory, and
driving on the new reference trajectory.

9. The information processing device according to claim 1, wherein
the one or more hardware processors generate the plurality of nodes for each of the operations included in the avoidance patterns, and when the generated nodes satisfy a predetermined second condition, stop generation of nodes with respect to an operation for which nodes are not generated.

10. The information processing device according to claim 1, wherein the one or more hardware processors are further configured to:
output information based on the selected trajectory candidate.

11. An information processing method implemented by a computer, the method comprising:
generating, on a basis of one or more avoidance patterns each indicating one or more operations of a mobile object for avoiding an object, a plurality of nodes at positions corresponding to the operations indicated by the avoidance patterns to avoid a first object on a first trajectory;
searching for, among a plurality of trajectory candidates connecting the plurality of nodes, a trajectory candidate having a moving cost smaller than a moving cost of another trajectory candidate for each of the avoidance patterns; and
selecting the trajectory candidate having the moving cost smaller than the moving cost of the other trajectory candidate among one or more trajectory candidates searched for each of the avoidance patterns.

12. A computer program product having a non-transitory computer readable medium including programmed instructions, wherein the instructions, when executed by a computer, cause the computer to perform:
generating, on a basis of one or more avoidance patterns each indicating one or more operations of a mobile object for avoiding an object, a plurality of nodes at positions corresponding to the operations indicated by the avoidance patterns to avoid a first object on a first trajectory;
searching for, among a plurality of trajectory candidates connecting the plurality of nodes, a trajectory candidate having a moving cost smaller than a moving cost of another trajectory candidate for each of the avoidance patterns; and
selecting the trajectory candidate having the moving cost smaller than the moving cost of the other trajectory candidate among one or more trajectory candidates searched for each of the avoidance patterns.

13. An information processing system comprising:
a learning device and an information processing device, wherein
the information processing device comprises:
one or more first hardware processors configured to,
generate, on a basis of one or more avoidance patterns each indicating one or more operations of a mobile object for avoiding an object, a plurality of nodes at positions corresponding to the operations indicated by the avoidance patterns to avoid a first object on a first trajectory,
search for, among a plurality of trajectory candidates connecting the plurality of nodes, a trajectory candidate having a moving cost smaller than a moving cost of another trajectory candidate for each of the avoidance patterns, and
select the trajectory candidate having the moving cost smaller than the moving cost of the other trajectory candidate among one or more trajectory candidates searched for each of the avoidance patterns, and
the learning device comprises:
one or more second hardware processors configured to obtain information used for the one or more first hardware processors to generate the nodes by learning.

14. A vehicle control system adapted to control a vehicle, the vehicle control system comprising:
an information processing device configured to generate a trajectory of the vehicle; and
a power control device configured to control a power unit for driving the vehicle on a basis of the trajectory, wherein
the information processing device comprises:
one or more hardware processors configured to
generate, on a basis of one or more avoidance patterns each indicating one or more operations of a mobile object for avoiding an object, a plurality of nodes at positions corresponding to the operations indicated by the avoidance patterns to avoid a first object on a first trajectory,
search for, among a plurality of trajectory candidates connecting the plurality of nodes, a trajectory candidate having a moving cost smaller than a moving cost of another trajectory candidate for each of the avoidance patterns, and
select the trajectory candidate having the moving cost smaller than the moving cost of the other trajectory candidate among one or more trajectory candidates searched for each of the avoidance patterns.
